(19) United States
(12) Patent Application Publication
(10) Pub. No.: US 2006/0049916 A1
(43) Pub. Date: Mar. 9, 2006

(54) Communication device and portable electronic instrument providing this communication device

(76) Inventor: Shoji Kuriki, Kanagawa (JP)

Correspondence Address: COOPER & DUNHAM, LLP, 1185 AVENUE OF THE AMERICAS, NEW YORK, NY, 10036, US

(21) Appl. No.: 11/209,504

(22) Filed: Aug. 23, 2005

(30) Foreign Application Priority Data
Aug. 30, 2004 (JP) 2004-250152

(51) Int. Cl. H04Q 5/22; G08B 13/14

(52) U.S. Cl. 340/10.1; 340/10.33; 340/10.34; 340/10.51; 340/572.1; 340/10.2

(57) ABSTRACT

A disclosed communication device includes a controller that outputs a signal; an antenna that transmits a radio wave which corresponds to the signal output from the controller and also outputs a signal which corresponds to a received radio wave to the controller; a first function that receives a signal, which responds to a first radio wave transmitted from the antenna, at the antenna; a second function that receives a second radio wave transmitted from another communication device at the antenna and also returns a signal output from the controller in response to the second radio wave from the antenna; and a unit that prevents the execution of the second function while the first function is being executed and prevents the execution of the first function while the second function is being executed.

### BACKGROUND OF THE INVENTION

1. Field of the Invention

The present invention generally relates to a communication device and a portable electronic instrument providing this communication device. The communication device has a data carrier [for example, a RFID (radio frequency identification) tag, a radio tag, an electronic tag, an IC tag, or a transponder] function, which receives and transmits information from/to a reader and writer via a contactless method by utilizing an electromagnetic field or a radio wave; and a reader and writer function (including an interrogator) that exchanges data with the RFID tag and processes the data by controlling a processor. Hereinafter, the first function is referred to as “RFID tag function”, the second function is referred to as “RW function”, and the reader and writer are referred to as “RW”. The portable electronic instrument providing the communication device is an instrument such as a mobile phone, a portable type memory, portable type digital audio equipment, a portable type digital camera, and a PDA (personal digital assistant).

2. Description of the Related Art

Recently, the RFID tag has been remarkably miniaturized and manufactured at low cost, and since the RFID tag can process an overwhelming amount of information compared with bar code, the RFID tag has been utilized for many articles and products by being attached thereon. For example, information such as the contents and the delivery history of an article being displayed in a shop have been stored in a memory of the RFID tag attached to the article, and it has become possible for a consumer to access the information of the article by only moving the article near to a RW. However, when many RWs are used around the RFID tags due to the spread of the RFID tags, an environment in which plural RFID tags and RWs exist in the same radio communication area occurs, and due to mutual interference, its good communications cannot be executed.

In order to solve this problem, in Patent Document 1, as shown in a block diagram of FIG. 8, a radio communication unit 200, which includes an active communication unit 202 providing two functions of a RFID tag function and a RW function and a passive communication unit 204 providing a RFID tag function, is disclosed. According to this radio communication unit 200, the passive communication unit 204 returns a response signal to the outside by receiving a request signal from the outside, and the active communication unit 202 transmits a request signal to the outside and also receives a response signal from the outside. The passive communication unit 204 can receive request signals such as a sleep request signal and a sleep cancellation request signal, in addition to a reading request signal and a writing request signal from the outside. The passive communication unit 204 shifts to a sleep state when receiving the sleep request signal so as not to respond to the reading request and the writing request from the outside. For example, when plural passive communication units 204 exist in the same radio communication area, by setting the passive communication units 204 except a specific passive communication unit 204 in the sleep state, a problem where a response from the passive communication unit 204 interferes with other passive communication units 204 is avoided. Then the sleep state is held in a state holding unit 206 of the passive communication unit 204 and is maintained until cancelled by receiving the sleep cancellation request signal.

The active communication unit 202 can transmit request signals such as a sleep request signal and a sleep cancellation request signal, in addition to a reading request signal and a writing request signal to the outside, and can receive a response signal for the transmitted signal. By transmitting the sleep request signal, the active communication unit 202 can make a destination passive communication unit 204 shift to the sleep state, and also can make the destination passive communication unit 204 cancel the sleep state by transmitting the sleep cancellation request signal. The active communication unit 202 refers to the state holding unit 206 in the passive communication unit 204 before transmitting a request signal, and determines whether the passive communication unit 204 is in the sleep state. If the passive communication unit 204 is in the sleep state, the transmission of the request signal is stopped. By this method, for example, in a case where plural active communication units 202 exist in the same communication area, the problem of mutual request signal interference can be avoided.

On the other hand, the spread of the contactless IC card is remarkable; for example, “Suica” (a registered trademark) being handled by JR East (East Japan Railway Company) has been practically used as a commuter ticket and a train ticket. In this, the basic function and the circuit structure of the contactless IC card are the same as the RFID tag; therefore, in the present invention, the RFID tag is defined as a concept in which the contactless IC card is included, and without distinguishing the contactless IC card from the RFID tag, the contactless IC card is described as the RFID tag.

The contactless IC card has an advantage for portability; however, when a user carries several IC cards, they become bulky and portability is lost. In order to solve this problem, an instrument in which the function of the contactless IC card is provided in a portable terminal is disclosed in Patent Document 2. In the invention disclosed in this Patent Document 2, by adding the function of the contactless IC card to a portable terminal, which provides a communication function, a data communication processing function, and an information processing function, for example, a mobile phone, a PHS (personal handy-phone system) terminal, a PDA (personal digital assistant), a car telephone, etc., a user can enjoy a service similar to the IC card service without having the IC card. In addition, a contactless IC card communication unit can use a battery as its power source and can gain desirable amplifying operations; therefore, the usable communication range of the contactless IC card communication unit can be increased, and the usability becomes excellent compared with the conventional contactless IC card.

[Patent Document 1] Japanese Laid-Open Patent Application No. 2003-150916

[Patent Document 2] Japanese Laid-Open Patent Application No. 2003-244014

Circuit structures of a general RW and a general RFID tag are shown in FIG. 9. In FIG. 9, a RW 200 consists of a bit coding unit for modulation 202, a modulation circuit 204, a bit coding unit for demodulation 206, a demodulation circuit 208, a driver 210, an antenna 212, a RW controller 214, and a controller 216. A RFID tag 250 consists of a bit coding unit for modulation 252, a modulation circuit 254, a bit coding unit for demodulation 256, a demodulation circuit 258, an antenna 260, a TAG controller 262, and a memory 264.

In this structure, the controller 216 provides a memory that stores commands and information and gives an instruction and information to the RW controller 214. The RW controller 214 controls communication of the RW 200, and sends a command and information sent from the controller 216 to the bit coding unit for modulation 202. The bit coding unit for modulation 202 converts the input command and information into coded serial data by conforming to a system such as an NRZ (non-return-to-zero) coding system and a Manchester coding system. The modulation circuit 204 modulates a carrier wave by using the coded data. The modulated carrier wave is amplified by the driver 210, and is transmitted from the antenna 212 as a radio wave. In this, when data are transmitted, the driver 210 has been activated by the RW controller 214 in advance.

When the antenna 260 of the RFID tag 250 receives a radio wave transmitted from the RW 200, an electromotive force is generated at the antenna 260. This electromotive force is rectified and given to various circuits (not shown) included in the RFID tag 250. A signal received at the antenna 260 is demodulated by the demodulation circuit 258 and a coded serial signal is restored to a digital signal by the bit coding unit for demodulation 256, and the digital signal is input to the TAG controller 262. The TAG controller 262 controls communication of the RFID tag 250, extracts desired data from the memory 264 based on the input signal, and sends the data to the bit coding unit for modulation 252. The bit coding unit for modulation 252 encodes the data sent from the TAG controller 262 by conforming to a system such as the NRZ coding system and the Manchester coding system. The coded data are modulated at the modulation circuit 254 and transmitted from the antenna 260.

The RW 200 receives the data transmitted from the RFID tag 250 at the antenna 212 and sends the data to the demodulation circuit 208. The data are demodulated at the demodulation circuit 208, and the coded serial data are restored to digital data at the bit coding unit for demodulation 206. The restored data are input to the controller 216 via the RW controller 214 and are processed.

As mentioned above, since the power of the general RFID tag 250 is supplied from the antenna 260, at the reply system in which a signal is transmitted from the RFID tag 250 to the RW 200, a load modulation system, in which the power consumption is low, is adopted. In addition, at the RW 200 side, since the power for the RFID tag 250 is supplied from the antenna 212, an ASK (amplitude shift keying) modulation, which has excellent power transmitting performance, is generally used.

As the standard with respect to the communications between the RFID tag and the RW utilizing the 13.56 MHz band, there are ISO 14443 standard being a Proximity Type and the ISO 15693 standard being a Vicinity Type. The contents of the ISO 14443 standard are shown in Table 1. As is understandable from Table 1, the modulation system and the coding system in the case of transmitting a signal from the RW to the RFID tag are not always equal to the modulation system and the coding system in the case of transmitting a signal from the RFID tag to the RW. For example, in case of Type A, the coding system of a case in which a signal is transmitted from the RW to the RFID tag is a modified mirror system; however the coding system of a case in which a signal is transmitted from the RFID tag to the RW is a Manchester system. In addition, as the modulation system of the case in which a signal is transmitted from the RW to the RFID tag, the ASK modulation system is adopted in all types. However, as the modulation system of the case in which a signal is transmitted from the RFID tag to the RW, an ASK modulation system of a sub-carrier is adopted for Type A, and a BPSK (binary phase shift keying) modulation system of a sub-carrier is adopted for Type B.

TABLE 1

| | |
|---|---|
| Communication | ISO 14443-2 |
| Standard | |

| | | Type | | |
|---|---|---|---|---|
| | | Type A | Type B | Type C |
| RW → | Center | 13.56 MHz | | |
| RFID | Carrier | | | |
| | Frequency | | | |
| | AM | 100% | 10% | |
| | Modulation | | | |
| | Sub-carrier | NON | | |
| | Modulation | ASK | | |
| | System | | | |
| | Coding | Modified | NRZ | Manchester |
| | System | Mirror | | |
| RFID → | Reply | Load Modulation | | |
| RW | System | | | |
| | Communication | Reply after recognizing a | | |
| | with RW | specific call code from RW | | |
| | Modulation | ASK of | BPSK of | ASK |
| | System | Sub- | Sub- | |
| | | carrier | carrier | |
| | Sub-carrier | 847.5 kHz | | NON |
| | Coding | Manchester | NRZ | Manchester |
| | System | | | |
| | Communication | 106 kbps | | 212 kbps |
| | Speed | | | |

As mentioned above, since the system is different between the case in which the signal is transmitted from the RW to the RFID tag and the case in which the signal is transmitted from the RFID tag to the RW, as mentioned in Patent Document 1, in a case where the RFID tag function is added to the RW function, as shown in FIG. 8, two circuits of the active communication unit 202 being the RW and the passive communication unit 204 being the RFID tag 204 must be provided separately.

In addition, as mentioned above, in a case where functions of the RW and the RFID tag are provided independently, when the active communication unit 202 is working, since the sleep state has been canceled at the passive communication unit 204, it is considered that the passive communication unit 204 may respond to a request signal from the active communication unit 202 of the radio communication unit 200 of its own or from the outside.

Furthermore, two circuits and means being the RW circuit and the RFID tag circuit are provided; therefore, the size of the circuits becomes large, and this may effect a cost increase.

In addition, for the instrument disclosed in Patent Document 2, only the function of the contactless IC card is added to the portable terminal and the function of the RW is not provided; therefore, in order to read the information of the RFID tag, it is necessary to provide the RW separately.

### SUMMARY OF THE INVENTION

It is a general object of the present invention to provide a communication device and a portable electronic instrument providing this communication device, in which both of the functions of a RW and a RFID tag are provided; the period using the RW function and the period using the RFID tag function can be clearly separated; and the circuit size is small and the cost is low.

Features and advantages of the present invention are set forth in the description that follows, and in part will become apparent from the description and the accompanying drawings, or may be learned by practice of the invention according to the teachings provided in the description. Objects as well as other features and advantages of the present invention will be realized and attained by a communication device and a portable electronic instrument providing this communication device particularly pointed out in the specification in such full, clear, concise, and exact terms as to enable a person having ordinary skill in the art to practice the invention.

To achieve these and other advantages in accordance with the purpose of the present invention, the present invention provides a communication device. The communication device includes a controller that outputs a signal; an antenna that transmits a radio wave which corresponds to the signal output from the controller and also outputs a signal which corresponds to a received radio wave to the controller; a first function that receives a signal, which responds to a first radio wave transmitted from the antenna, at the antenna; a second function that receives a second radio wave transmitted from another communication device at the antenna and also returns a signal output from the controller in response to the second radio wave from the antenna; and a unit that prevents the execution of the second function while the first function is being executed and prevents the execution of the first function while the second function is being executed.

According to the above-mentioned structure, it is preferable that the controller include a unit that permits the execution of the first function when the controller receives a first function start signal and permits the execution of the second function when the controller receives a second function start signal at an idle status in which the communication device is executing neither the first function nor the second function.

According to another aspect of the present invention, it is preferable that the communication device further include a unit that restores the idle status when the first function is finished and restores the idle status when the second function is finished.

According to another aspect of the present invention, it is preferable that the communication device further include a second function starting unit that detects an electric change induced at the antenna and outputs a signal corresponding to the second function start signal.

According to another aspect of the present invention, it is preferable that the communication device further include a switch that selects either the first function or the second function.

According to another aspect of the present invention, it is preferable that the communication device further include a modulation unit that modulates the signal output from the controller, a demodulation unit that demodulates the signal output from the antenna, and that the modulation system of the modulation unit and the demodulation system of the demodulation unit be the same.

According to another aspect of the present invention, it is preferable that the modulation system be an ASK modulation system.

According to another aspect of the present invention, it is preferable that the communication device further include an encoding unit that encodes a first signal output from the controller, and a decoding unit that decodes a signal output from the demodulation unit, where an encoding system of the encoding unit and a decoding system of the decoding unit are the same.

According to another aspect of the present invention, the communication device further includes a power generating unit that generates power by utilizing power induced at the antenna by the second radio wave.

According to another embodiment of the present invention, the present invention provides a communication device. The communication device includes a controller that outputs a signal; a first modulation unit that modulates the signal output from the controller by a first modulation system; a second modulation unit that modulates the signal output from the controller by a second modulation system being different from the first modulation system; a modulation selecting unit that selectively sends the signal output from the controller to the first modulation unit or the second modulation unit; an antenna that transmits a radio wave corresponding to a signal output from the first modulation unit or the second modulation unit selected at the modulation selecting unit; a first demodulation unit that demodulates a signal corresponding to a radio wave received at the antenna by a first demodulation system; a second demodulation unit that demodulates a signal corresponding to a radio wave received at the antenna by a second demodulation system; a demodulation selecting unit that selectively sends a signal corresponding to the radio wave received at the antenna to the first demodulation unit or the second demodulation unit and also sends a signal demodulated at the first demodulation unit or the second demodulation unit to the controller; a first function that selects the first modulation unit by the modulation selecting unit and selects the first demodulation unit by the demodulation selecting unit, transmits a first radio wave from the antenna by modulating the signal output from the controller at the first modulation unit, and demodulates a signal responding to the first radio wave at the first demodulation unit and sends the demodulated signal to the controller; a second function that selects the second modulation unit by the modulation selecting unit and selects the second demodulation unit by the demodulation selecting unit, receives a second radio wave transmitted from another communication device at the antenna, demodulates a signal corresponding to the second radio wave at the second demodulation unit and sends the demodulated signal to the controller, and returns a signal output from the controller by corresponding to the signal corresponding to the second radio wave from the antenna to another communication device; and a unit that prevents the execution of the second function while the first function is being executed and prevents the execution of the first function while the second function is being executed.

### EFFECT OF THE INVENTION

According to the present invention, since the first function (RW function) and the second function (RFID tag function) use one antenna in common, the circuit space becomes remarkably smaller than that of the conventional communication device that provides an exclusive circuit for the first function and an exclusive circuit for the second function. In addition, in a case where the communication device is performing the function of the RW, even when the communication device is in the communication area where a RW and another communication device functioning as the RW exist, the RW function of the communication device is maintained and is not changed to the RFID tag function until the RW function finishes. In addition, in a case where the communication device is performing the function of the RFID tag, the function of the RFID tag is not changed to the RW by discontinuing the function of the RFID tag. Therefore, the information presently being communicated is not discontinued in the middle of the communication of the information, and even in an environment where plural RWs, RFID tags, and communication devices providing both the functions exist adjacently, the radio waves being transmitted/received among them do not mutually interfere with each other.

### BRIEF DESCRIPTION OF THE DRAWINGS

Other objects, features and advantages of the present invention will become more apparent from the following detailed description when read in conjunction with the accompanying drawings, in which:

FIG. 1 is a diagram explaining functions of a communication device according to the present invention;

FIG. 2 is a block diagram explaining a structure of a communication device according to a first embodiment of the present invention;

FIG. 3 is a diagram explaining the changing over of functions that are executed by the communication device shown in FIG. 2;

FIG. 4 is a flowchart explaining an operation of the communication device according to the first embodiment of the present invention;

FIG. 5 is a block diagram showing a modified example of the communication device according to the first embodiment of the present invention;

FIG. 6 is a block diagram showing another modified example of the communication device according to the first embodiment of the present invention;

FIG. 7 is a block diagram explaining a structure of a communication device according to a second embodiment of the present invention;

FIG. 8 is a diagram explaining functions and a structure of a conventional communication device; and

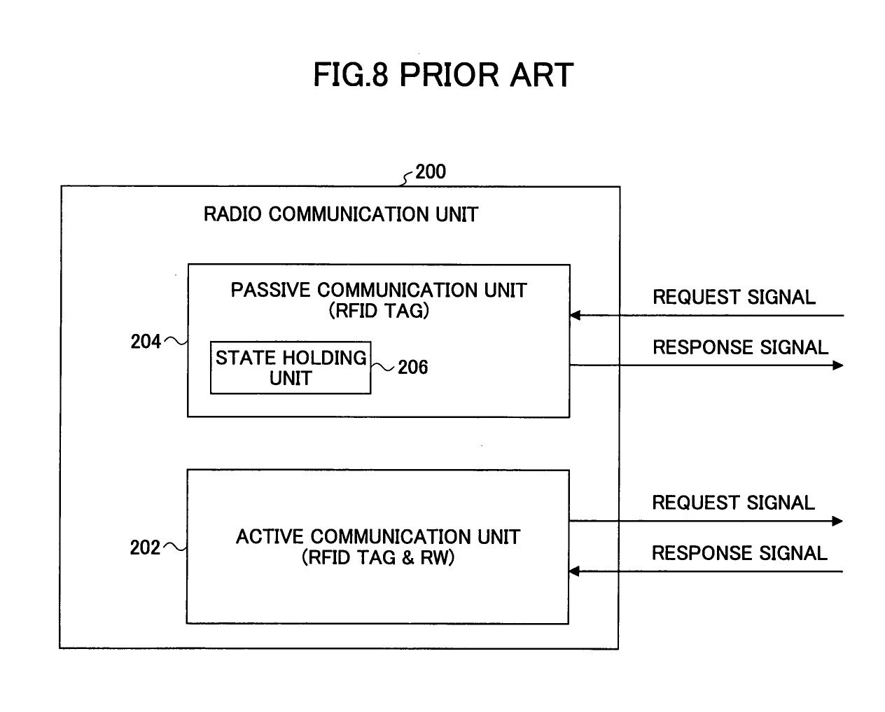

FIG. 9 is a block diagram showing structures of a conventional RW and a conventional RFID tag.

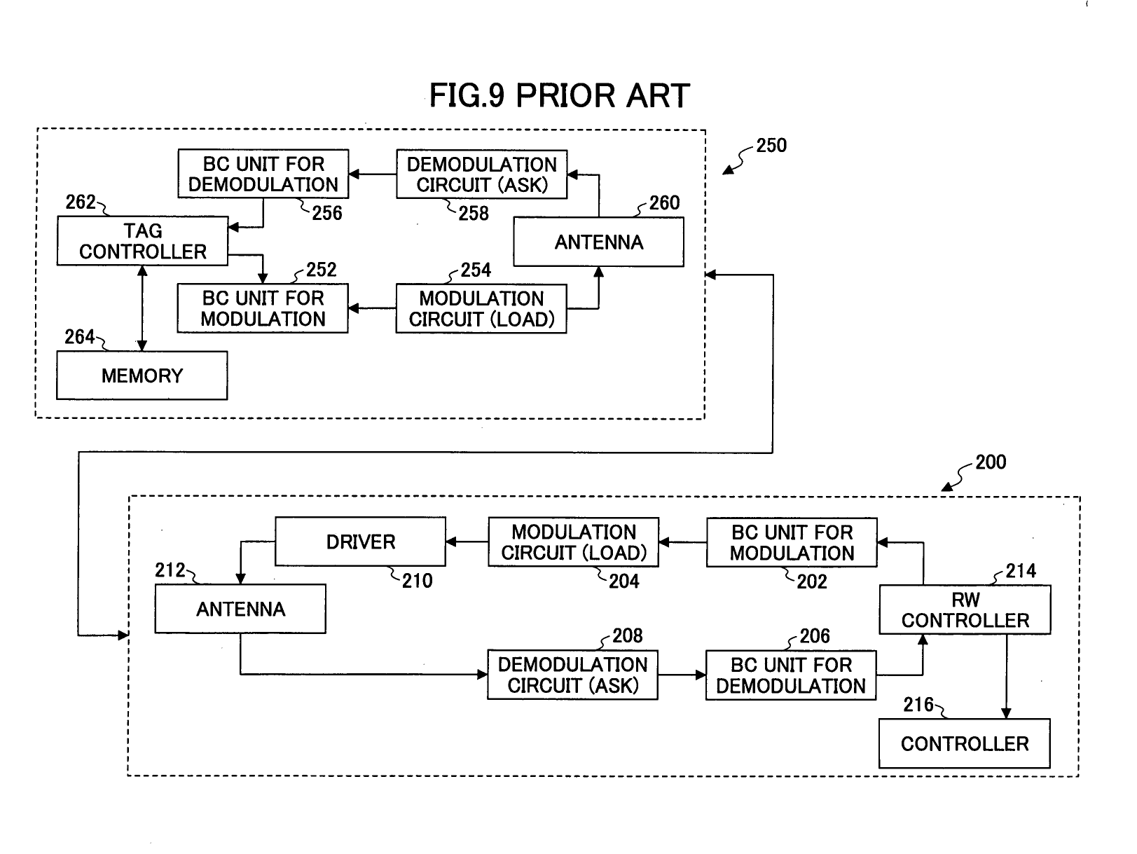

### DESCRIPTION OF THE PREFERRED EMBODIMENTS

In the following, embodiments of the present invention are described with reference to the accompanying drawings.

### BEST MODE OF CARRYING OUT THE INVENTION

### First Embodiment

(1) Function of Communication Device

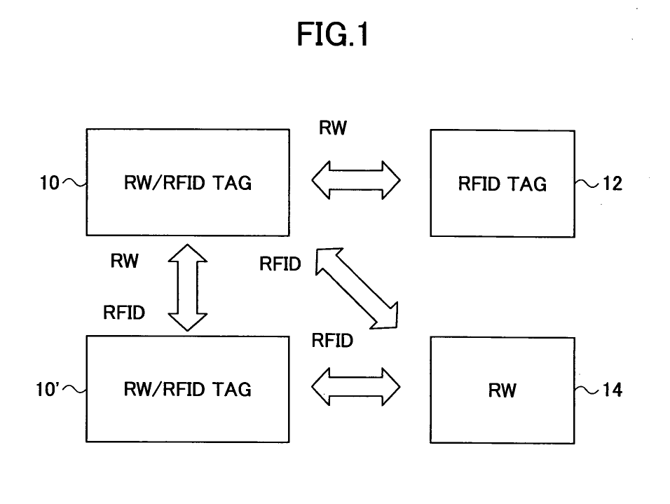

FIG. 1 is a structural diagram of a communication system utilized by communication devices according to the present invention. In FIG. 1, the communication device (RW/RFID tag) of the present invention shown by the reference number 10 provides a function of a RFID tag or of an AIDC (automatic identification & data capture) which receives a signal output from another communication device and returns a signal corresponding to the received signal, and a function of a RW which reads information from another RFID tag and/or writes information in another RFID tag. Specifically, the communication device 10 provides a first function (RW function) working as a RW which reads information stored in a RFID tag 12 and also rewrites information stored in the RFID tag 12, and a second function (RFID tag function) working as a RFID tag which transmits necessary information to a RW 14 corresponding to a request from the RW 14 and rewrites information stored in the communication device 10 based on an instruction of the RW 14. In addition, the communication device 10 works as the RFID tag or the RW selectively between another communication device 10′ providing the RFID tag function & the RW function and the communication device 10. For example, when the other communication device 10′ functions as the RW, the communication device 10 works as the RFID tag, and when the other communication device 10′ functions as the RFID tag, the communication device 10 works as the RW.

It is preferable that the communication device 10 be a portable device. As this portable device, for example, a mobile phone, a portable memory (it is not a problem that the contents of information to be stored are any of voice, image, and text), portable type digital audio equipment, a portable type digital camera, and a PDA are considered. However, the communication device 10 is not limited to such devices, and the communication device 10 can be a device attached to a facility fixed on land or a device being detachable from the facility, or a device installed in equipment being movable on land (for example, a car) in a fixed state or a detachable state.

(2) Structure of Communication Device

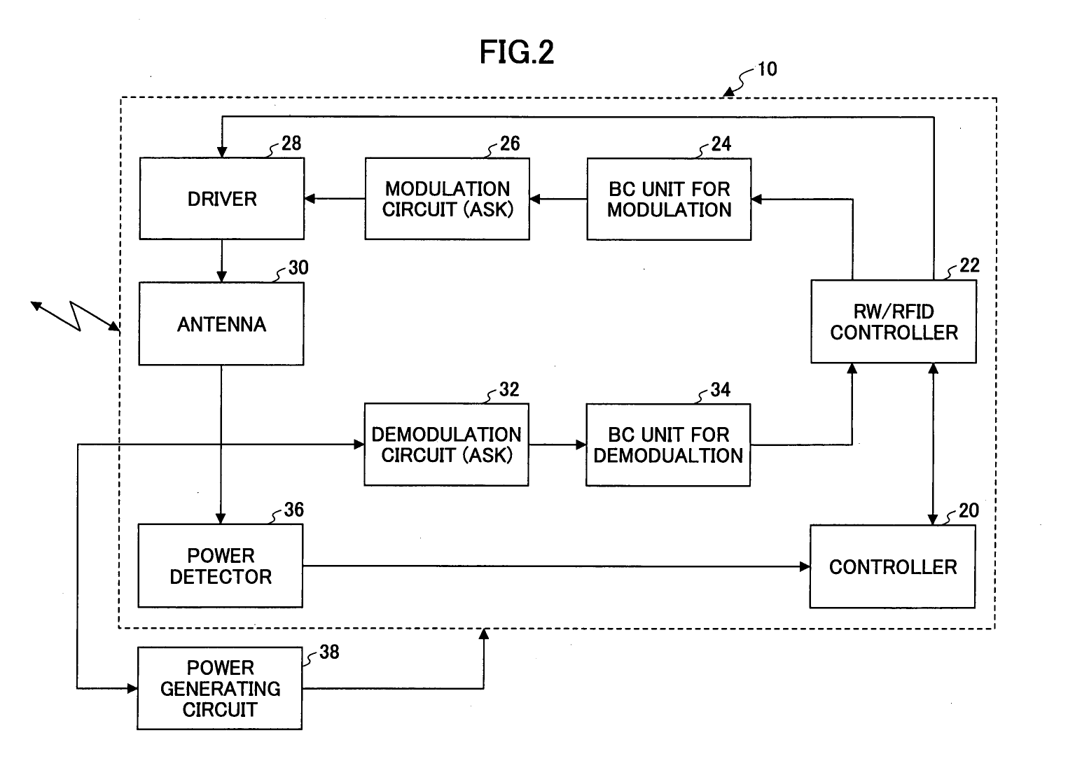

FIG. 2 is a diagram of a structure of the communication device 10 shown based on functions. The communication device 10 provides a controller 20, a RW/RFID controller 22, a bit coding unit for modulation (encoding unit) 24, a modulation circuit (modulation unit) 26, a driver 28, an antenna 30, a demodulation circuit (demodulation unit) 32, a bit coding unit for demodulation (decoding unit) 34, a power detector (RFID starting unit) 36, and a power generating circuit 38 that supplies power to these structural elements.

The controller 20 controls the whole of the communication device 10, and can send/receive necessary information such as commands and data to/from the RW/RFID controller 22. A first function start signal, which makes the communication device 10 work as the RW, is included in this information.

The RW/RFID controller 22 works based on a signal sent from the controller 20 and sends/receives necessary information to/from the controller 20. In addition, based on an instruction from the controller 20, the RW/RFID controller 22 sends transmission information to the bit coding unit for modulation 24 and also sends a signal received from the bit coding unit for demodulation 34 to the controller 20.

The bit coding unit for modulation 24 applies bit encoding to a serial digital signal output from the RW/RFID controller 22. As the bit encoding system, various systems such as a NRZ system, a Manchester system, a single pole RZ system, a mirror system, and a pulse position system have been proposed, and any of the systems can be adopted. In addition, the bit coding unit for modulation 24 can be realized by an electronic circuit; however, in the embodiment, it is realized by software installed in the memory of the communication device 10. Therefore, the circuit built in the communication device 10 can be miniaturized. In addition, in a case where the necessity for changing the bit coding system occurs, it is possible that only software need be exchanged without changing the circuit structure.

The modulation circuit 26 modulates (amplitude modulation, frequency modulation, or phase modulation is applied) a carrier wave by using a base band signal encoded at the bit coding unit for modulation 24. As the modulation system, an ASK modulation system, a FSK (frequency shift keying) modulation system, a PSK (phase shift keying) modulation system, a BPSK modulation system, a modulation system using a sub-carrier, etc., have been proposed, and any of the systems can be adopted; however, in the embodiment, the ASK modulation system, which is being widely utilized in Japan at present, is adopted.

The driver 28 is activated by the RW/RFID controller 22 when the communication device 10 outputs a signal through the antenna 30, and amplifies the signal modulated at the modulation circuit 26 and sends the signal to the antenna 30.

The antenna 30 (or antenna coil) transmits the signal amplified at the driver 28 as a radio wave. In addition, the antenna 30 receives a radio wave transmitted from, the other communication device 10′ that provides both functions of the RFID tag and the RW being similar to the communication device 10, the RFID tag 12, or the RW 14. As the communication system between the communication device 10 and the other communication devices (the same kind of communication devices, RWs, or RFID tags), an electromagnetic coupling system, an electromagnetic induction system, and a radio wave system are known, and any of the systems can be adopted.

The demodulation circuit 32 demodulates a signal output from the antenna of the other communication device 10′ (refer to FIG. 1). The demodulation system corresponds to the modulation system of the corresponding device (the other communication device 10′, the RFID tag 12, or the RW 14), which communicates with the communication device 10. In the embodiment, the ASK demodulation system is adopted corresponding to the modulation system at the modulation circuit 26.

The bit coding unit for demodulation 34 decodes the signal demodulated at the demodulation circuit 32 to a serial digital signal, and sends the signal to the RW/RFID controller 22. As the bit coding system, a decoding system corresponding to the bit coding unit for modulation 24 is adopted. Like the bit coding unit for modulation 24, the bit coding unit for demodulation 34 can be realized by software installed in the memory of the communication device 10. Therefore, the circuit to be built in the communication device 10 can be further miniaturized. In addition, in a case where the necessity for changing the bit coding system occurs, it is possible that only software need be exchanged without changing the circuit structure.

When the antenna 30 is positioned in a communication area formed by the other communication device 10′ functioning as the RW or the RW 14 (that is, within an area where the antenna 30 can detect a radio wave or a magnetic field generated by the other communication device 10′), the power detector 36 (RFID starting unit), based on the electric change caused by the change of the magnetic field occurring at the antenna coil (for example, the generation of an electromotive force or the change of voltage), sends a signal, which shows that the communication device 10 is positioned in a state where the communication device 10 should perform as the RFID tag, to the controller 20.

The power generating circuit 38 generates power based on a current induced in the antenna 30 by a radio wave or an alternating magnetic field received at the antenna 30, and supplies necessary power to the above-mentioned structural elements including in the communication device 10.

(3) Operation of Communication Device

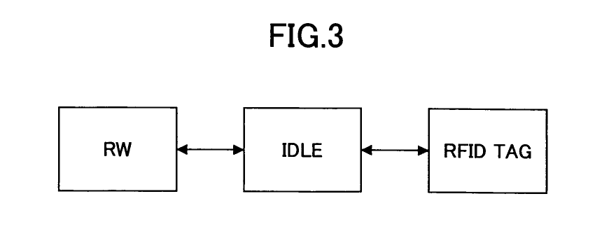

Next, an operation of the communication device 10 is explained. As mentioned above, since the communication device 10 provides the RW function and the RFID tag function and selects one of them selectively, the communication device 10 can be in one of a status that functions as the RW (RW status) and a status that functions as the RFID tag (RFID status). In the embodiment, as shown in FIG. 3, the communication device 10 provides, in addition to the RW status and the RFID status, an idle status (IDLE status) or a stand by status, which does not belong to the RW status and the RFID status.

(a) Idle Status

When the communication device 10 is in the idle status, the transmission of a radio wave from the antenna 30 is stopped. In addition, when the communication device 10 is in the idle status and the antenna 30 receives a radio wave transmitted from the other communication device 10′ or the RW 14 and a signal is output from the power detector 36 to the controller 20, the controller 20 outputs a signal (RFID start signal) to the RW/RFID controller 22 based on this signal, and the communication device 10 changes its status from the idle status to the RFID status. Further, when an instruction (RW start signal), which instructs the communication device 10 to change to the RW status, is output from the controller 20 to the RW/RFID controller 22 of the communication device 10, the communication device 10 changes its status from the idle status to the RW status.

(b) RW Function

In a case where the communication device 10 is made to function as the RW, based on an instruction from a host computer (not shown), the controller 20 outputs a necessary instruction (RW start signal) to the RW/RFID controller 22. The RW/RFID controller 22, based on the instruction supplied from the controller 20, generates a digital signal and outputs the digital signal to the bit coding unit for modulation 24. In a case where the communication device 10 functions as the RW, the communication device 10 is prevented from functioning as the RFID tag. Therefore, while the communication device 10 is functioning as the RW, even when the antenna 30 of the communication device 10 is positioned in a communication area of the antenna of the other communication device 10′ or the RW 14, the RW function of the communication device 10 is maintained, and the RFID tag function is not started by stopping the RW function.

The signal output from the RW/RFID controller 22 is encoded at the bit coding unit for modulation 24, the ASK modulation is applied to the encoded signal at the modulation circuit 26, the modulated signal is amplified at the driver 28 based on a control signal output from the RW/RFID controller 22, and the amplified signal is transmitted from the antenna 30 as a radio wave (a first radio wave).

The first radio wave transmitted from the antenna 30 is received at the antenna of the RFID tag 12 or the other communication device 10′ providing the RFID function positioned in the communication area of this first radio wave. The other communication device 10′ or the RFID tag 12, having received the first radio wave, processes the signal in the received radio wave in a built-in microprocessor, and transmits a signal corresponding to the received signal from the corresponding antenna.

The reply from the RFID tag 12 or the other communication device 10′ is received at the antenna 30 of the communication device 10, is demodulated at the demodulation circuit 32, is restored to a digital signal at the bit coding unit for demodulation 34, and the digital signal is sent to the RW/RFID controller 22. The signal received at the RW/RFID controller 22 is sent to the controller 20 corresponding to its necessity, and a predetermined process is applied to the received signal.

In this, since the signal transmitted from the communication device 10 is a signal to which the ASK modulation is applied, the demodulation circuit of the RFID tag 12 or the other communication device 10′, which receives this signal and demodulates it, must be a demodulation circuit that demodulates a signal to which the ASK modulation is applied. In addition, in order for the signal transmitted from the RFID tag 12 or the other communication device 10′ to be demodulated at the communication circuit 10, a signal transmitted from the RFID tag 12 or the other communication device 10′ must be a signal to which the ASK modulation is applied.

When the communication device 10 has finished the communication with the RFID tag 12 or the other communication device 10′, the controller 20 causes the communication device 10 to be restored to the idle status.

(c) RFID Tag Function

In a case where the communication device 10 is in the idle status, when the antenna 30 detects a radio wave transmitted or a magnetic field induced from the radio wave from the RW 14 or the other communication device 10′, an electric change (for example, an electromotive force) occurs in a circuit including the antenna 30. This electric change is detected at the power detector 36 and a detection signal corresponding to the detected result is input to the controller 20. The controller 20 outputs a signal to the RW/RFID controller 22 by responding to the signal sent from the power detector 36, and sets the RW/RFID controller 22 in a manner so that the communication device 10 functions as the RFID tag and is prevented from functioning as the RW.

On the other hand, the signal detected at the antenna 30 is demodulated at the demodulation circuit 32, the demodulated signal is restored to a digital signal by decoding at the bit coding unit for demodulation 34, and the digital signal is input to the RW/RFID controller 22. The digital signal input to the RW/RFID controller 22 is sent to the controller 20. The controller 20 sends information corresponding to the input digital signal to the RW/RFID controller 22. The RW/RFID controller 22 outputs the information received from the controller 20 to the bit coding unit for modulation 24. The bit coding unit for modulation 24 encodes the received signal. The coded signal is modulated at the modulation circuit 26. In addition, the modulated signal, based on the signal output from the RW/RFID controller 22, is amplified at the driver 28, and after this, is transmitted to the RW 14 or the other communication device 10′ from the antenna 30.

When the communications with the RW 14 or the other communication device 10′ are finished and the detection signal from the power detector 36 becomes zero, the output of the signal from the controller 20 to the RW/RFID controller 22 stops, and the communication device 10 is restored to the idle status.

(4) Alternative Operation of Communication Device

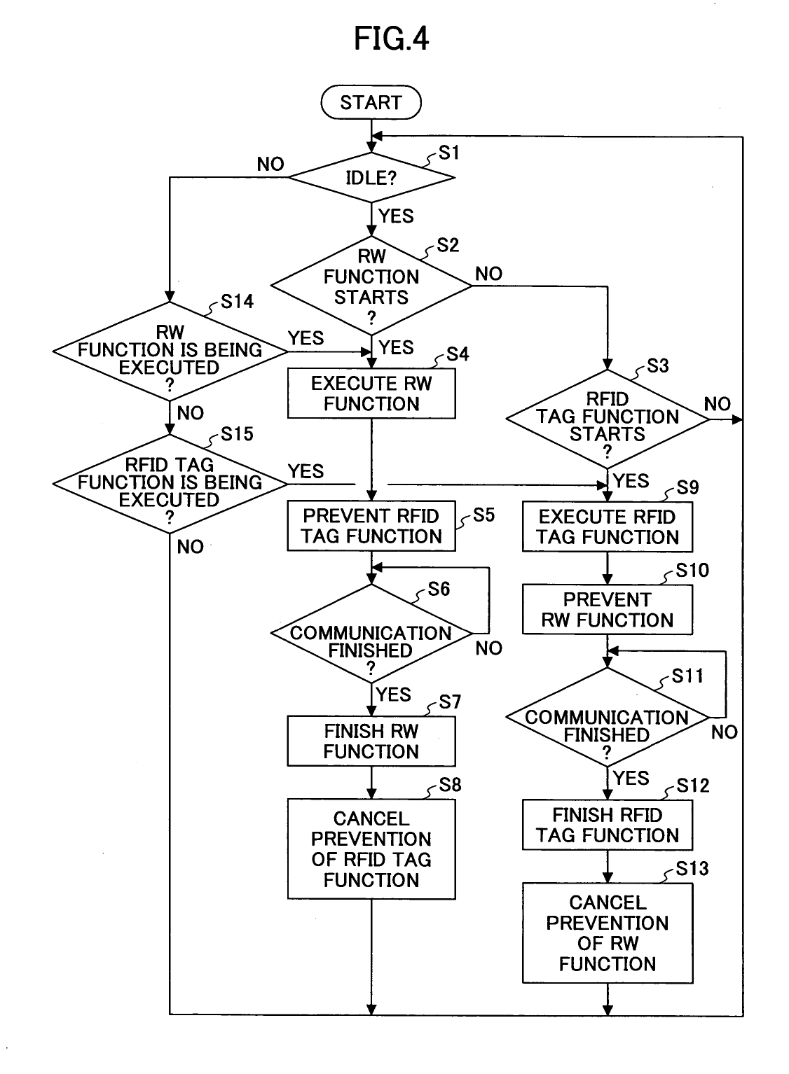

An example of a program, which makes the communication device 10 execute the RW function and the RFID tag function alternatively, is shown in FIG. 4. Referring to FIG. 4, the operation is explained. First, the communication device 10 determines whether the communication device 10 is in the idle status (S1). When the communication device 10 is in the idle status (YES at S1), it is determined whether the start signal of the RW function is output from the controller 20 (S2). When the RW start signal is output from the controller 20 (YES at S2), the communication device 10 starts (executes) the RW function (S4), and prevents the execution of the RFID tag function (S5). Next, when the communication of the RW function is finished (YES at S6), the communication device 10 finishes the RW function (S7), and cancels the prevention of the RFID tag function (S8). When the RW start signal is not output from the controller 20 (NO at S2), it is determined whether the start signal of the RFID tag function is output from the controller 20 (S3). When the RFID start signal is output from the controller 20 (YES at S3), the communication device 10 starts (executes) the RFID tag function (S9), and prevents the execution of the RW function (S10). Next, when the communication of the RFID tag function is finished (YES at S11), the communication device 10 finishes the RFID tag function (S12), and cancels the prevention of the RW function (S13). On the other hand, when it is determined that the communication device 10 is not in the idle status at S1, it is determined whether the communication device 10 is executing the RW function (S14). When the RW function is being executed (YES at S14), the RW function continues to be executed (S4). In addition, when it is determined that the communication device 10 is not in the idle status at S1 and the RW function is not being executed at S14, it is determined whether the communication device 10 is executing the RFID tag function (S15). When the RFID tag function is being executed (YES at S15), the RFID tag function is continued to be executed (S9).

As mentioned above, according to the communication device 10 of the first embodiment, the RW function and the RFID tag function are realized by a circuit that provides one antenna, a pair of modulation and demodulation circuits, a pair of bit coding units for modulation and demodulation, and this one circuit is used in common by the RW function and the RFID tag function; therefore, the circuit space becomes remarkably smaller than the space of the conventional communication device that provides an exclusive circuit for the RW function and an exclusive circuit for the RFID tag function.

In addition, in a case where the communication device 10 is in the function of the RW, even when the communication device 10 is in a communication area where a RW and another communication device functioning as the RW exist, the RW function of the communication device 10 is maintained and is not changed to the RFID tag function until the RW function finishes. In addition, in a case where the communication device 10 is in the function of the RFID tag, the function of the RFID tag is not changed to the RW by discontinuing the function of the RFID tag. Therefore, the information under present communications is not discontinued in the middle of the communications, and even in an environment where plural RWs, RFID tags, and communication devices 10 providing both the functions exist adjacently, the radio waves being transmitted/received among them do not mutually interfere.

(5) Modified Examples

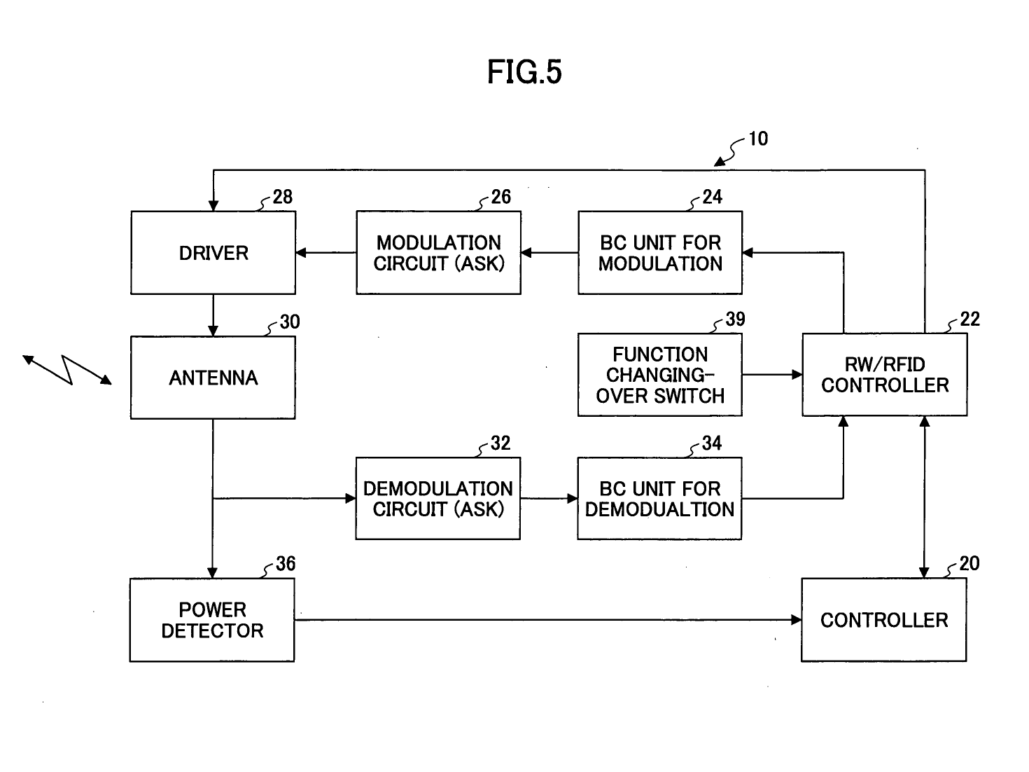

At the communication device 10 according to the above-mentioned embodiment, the idle status is set in general, the status is changed over to the RW status based on the instruction from the controller 20, and is changed over to the RFID tag status based on the signal from the power detector 36. However, as shown in FIG. 5, it is possible to provide a function changing-over switch 39 of a manual operation type, and this function changing-over switch 39 changes over the function from the RW function to the RFID tag function and also changes over in reverse. However, while the communication device 10 is functioning as the RW or the RFID tag, when the function is changed over by the function changing-over switch 39, it is necessary that the newly selected function be executed after the completion of the working function.

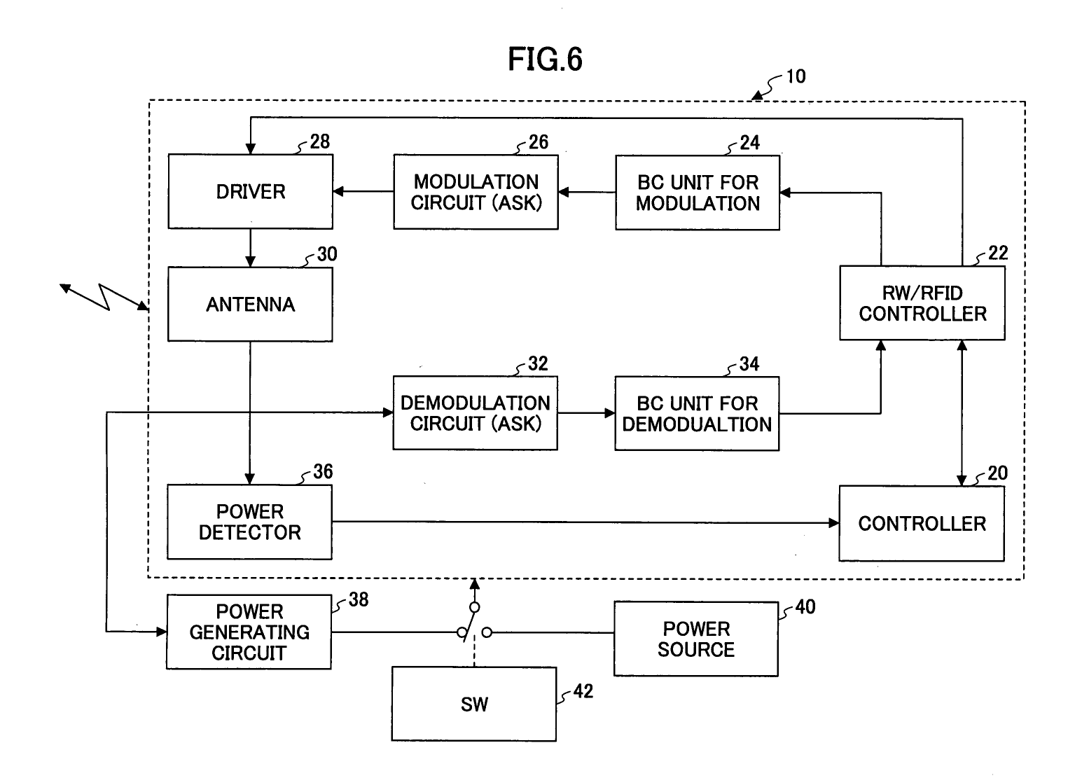

In addition, at the communication device 10 according to the above-mentioned embodiment, the power is generated at the power generating circuit 38 by utilizing the radio wave received at the antenna 30, and this generated power is supplied to each of the elements of the communication device 10. However, as shown in FIG. 6, it is possible to provide a power source 40 that can always supply stable power, and corresponding to the necessity, the power supply source is changed over from the power generating circuit 38 to the power source 40 by using a switch 42. In this case, the power source 40 can supply higher power to the antenna 30 and so on than the power that is generated at the power generating circuit 38; therefore, the communication range can be increased and stable communications can be executed.

### Second Embodiment

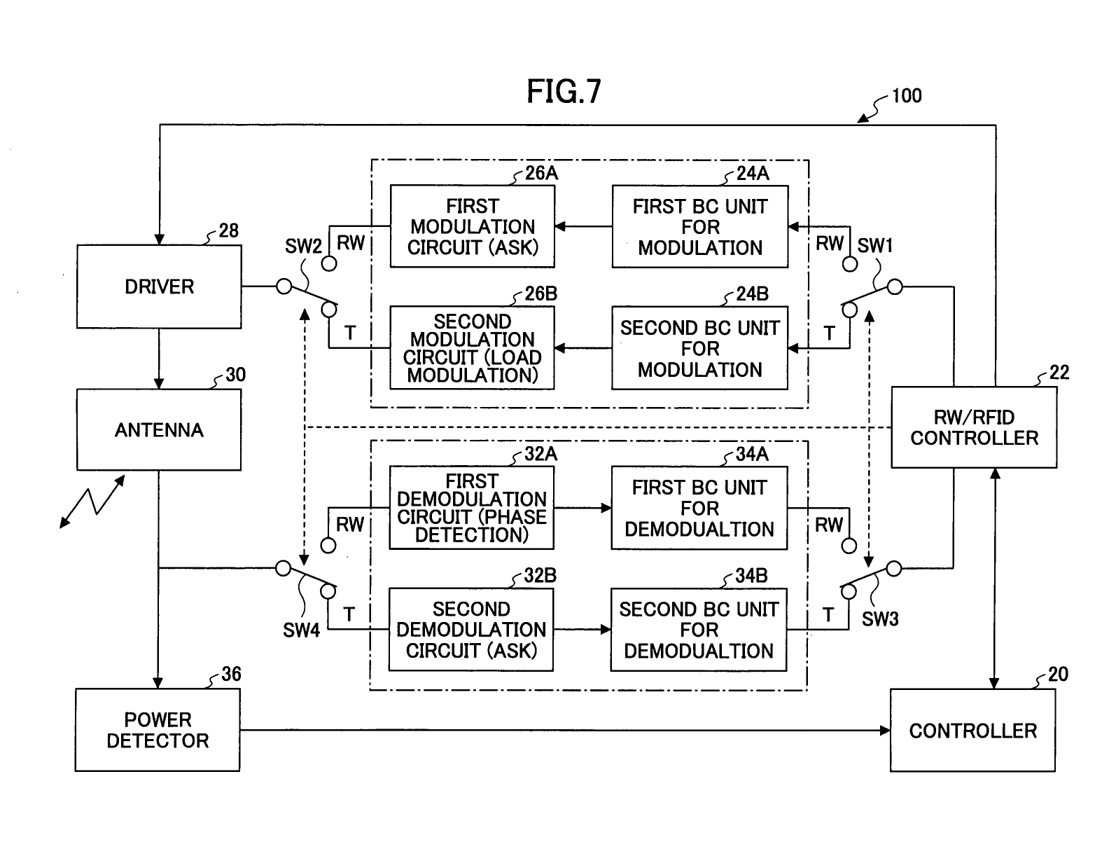

A communication device 100 according to a second embodiment is shown in FIG. 7. As shown in FIG. 7, this communication device 100 provides two systems of a modulation circuit & a bit coding unit for modulation and a demodulation circuit & a bit coding unit for demodulation. At the time when the communication device 100 functions as the RW or the RFID tag, the modulation circuit & the bit coding unit for modulation and the demodulation circuit & the bit coding unit for demodulation, which are used, are different from each other.

Specifically, the communication device 100 provides, between the RW/RFID controller 22 and the driver 28, a first modulation system that includes a first bit coding unit for modulation 24A and a first modulation circuit 26A that modulates a carrier wave by using a signal encoded at the first bit coding unit for modulation 24A and a second modulation system that includes a second bit coding unit for modulation 24B and a second modulation circuit 26B that modulates a carrier wave by using a signal encoded at the second bit coding unit for modulation 24B. The first bit coding unit for modulation 24A and the second bit coding unit for modulation 24B are connected to the RW/RFID controller 22 via a SW1 (modulation selecting unit). In addition, the first modulation circuit 26A and the second modulation circuit 26B are connected to the driver 28 via a SW2 (modulation selecting unit).

Similarly, the communication device 100 provides, between the RW/RFID controller 22 and the antenna 30, a first demodulation system that includes a first demodulation circuit 32A and a first bit coding unit for demodulation 34A that applies demodulation bit decoding to a signal output from the first demodulation circuit 32A, and a second demodulation system that includes a second demodulation circuit 32B and a second bit coding unit for demodulation 34B that applies demodulation bit decoding to a signal output from the second demodulation circuit 32B. The first bit coding unit for demodulation 34A and the second bit coding unit for demodulation 34B are connected to the RW/RFID controller 22 via a SW3 (demodulation selecting unit). In addition, the first demodulation circuit 32A and the second demodulation circuit 32B are connected to the antenna 30 via a SW4 (demodulation selecting unit).

A different coding and modulation system is adopted between the first modulation system and the second modulation system. For example, at the first modulation circuit 26A and the first bit coding unit for modulation 24A which are used when the communication device 100 functions as the RW, it is preferable that the modulation system and the coding system be in compliance with any of the types A to C of the ISO 14443 standard or the modulation system and the coding system be in compliance with the ISO 15693 standard. In addition, at the first demodulation circuit 32A and the first bit coding unit for demodulation 34A which are used when the communication device 100 functions as the RW, it is preferable that the demodulation system and the coding system be in compliance with any of the types A to C of the ISO 14443 standard or the demodulation system and the coding system be in compliance with the ISO 15693 standard.

In the demodulation system at the time when the communication device 100 works as the RFID tag, in order that the communications between a general purpose RFID tag and the communication device 100 according to the present invention can be executed, it is preferable that the demodulation system of the second demodulation circuit 32B and the modulation system of the first modulation circuit 26A that works at the time when the communication device 100 functions as the RW be the same. According to the embodiment, the ASK system, which complies with the above-mentioned ISO standard, is adopted. On the other hand, it is preferable that the decoding system of the second bit coding unit for demodulation 34B be the same as the coding system of the first bit coding unit for modulation 24A that works at the time when the communication device 100 functions as the RW. As a matter of course, it is preferable that the system to be adopted be in compliance with the ISO standard. In addition, like the general purpose RFID tag, it is preferable that the decoding system of the second bit coding unit for modulation 34B that works when the communication device 100 functions as the RFID tag and the modulation system of the second modulation circuit 26B comply with the ISO standard. However, it is necessary that the system of the second bit coding unit for modulation 24B be the same as the system of the first bit coding unit for demodulation 34A that works when the communication device 100 functions as the RW.

By considering the above-mentioned points, according to the embodiment, actually, the first modulation circuit 26A of the first modulation system adopts the ASK modulation system, and the first bit coding unit for modulation 24A adopts a coding system corresponding to the ASK modulation system. In addition, the second modulation circuit 26B of the second modulation system adopts the load modulation system and the second bit coding unit for modulation 24B adopts a coding system corresponding to the load modulation system. Then the first demodulation circuit 32A of the first demodulation system adopts a phase detection system, and the first bit coding unit for demodulation 34A adopts a bit coding system corresponding to the ASK modulation system. And finally, the second modulation circuit 26B of the second modulation system adopts a load modulation system, and the second bit coding unit for modulation 24B adopts a bit coding system corresponding to the load modulation system.

In the second embodiment, the structure of the communication device 100 is the same as that of the communication device 10, except for the structure mentioned above.

According to the communication device 100 providing the above-mentioned structure, when the communication device 100 functions as the RW, the switches SW1 to SW4 are set to the opposite side (RW side) of the positions shown in FIG. 7 by the instruction output from the RW/RFID controller 22. With this, the RW/RFID controller 22 and the driver 28 are connected via the first bit coding unit for modulation 24A and the first modulation circuit 26A, and the antenna 30 and the RW/RFID controller 22 are connected via the first demodulation circuit 32A and the first bit coding unit for demodulation 34A. Consequently, based on the instruction output from the controller 20, the RW/RFID controller 22 transmits a radio wave from the antenna 30 via the first bit coding unit for modulation 24A, the first modulation circuit 26A, and the driver 28. A reply received at the antenna 30 is sent to the controller 20 via the first demodulation circuit 32A, the first bit coding unit for demodulation 34A, and the RW/RFID controller 22.

When the communication device 100 functions as the RFID tag, the switches SW1 to SW4 are set to the positions (T side) shown in FIG. 7 by the instruction output from the RW/RFID controller 22. With this, the RW/RFID controller 22 and the driver 28 are connected via the second bit coding unit for modulation 24B and the second modulation circuit 26B, and the antenna 30 and the RW/RFID controller 22 are connected via the second demodulation circuit 32B and the second bit coding unit for demodulation 34B. Consequently, a signal received at the antenna 30 is sent to the controller 20 via the second demodulation circuit 32B, the second bit coding unit for demodulation 34B, and the RW/RFID controller 22. At the same time, an electromotive force at the antenna 30 is detected by the power detector 36, and the detection result is sent to the controller 20. In addition, based on an instruction output from the controller 20, the RW/RFID controller 22 transmits a radio wave for reply from the antenna 30 via the second bit coding unit for modulation 24B, the second modulation circuit 26B, and the driver 28.

As mentioned above, at the communication device 100 according to the second embodiment, the coding system at the bit coding units for modulation & demodulation and the modulation & demodulation system at the modulation & demodulation circuits are made to comply with the ISO standard, and the circuits and means (the modulation & demodulation circuits and the bit coding units for modulation & demodulation) are different between two cases in which the communication device 100 is made to function as the RW and as the RFID tag. Further, the coding system and the modulation & demodulation system, which are selected at the time when transmitting or receiving a signal, are made to be the same. Therefore, in addition to the communications between the communication devices 100 according to the present invention, the communications between the communication device 100 and the general purpose RFID tag can be executed. In addition, when the communication device 10 or 100 according to the present invention is built in a portable instrument such as a mobile phone, a PDA, and a digital camera, the RW and the RFID tag, which are additionally carried conventionally, are not required.

In this, while it is not referred to above, the modified examples explained by referring to FIGS. 5 and 6 of the first embodiment can be applied to the communication device 100 according to the second embodiment.

In addition, according to the communication device 100 of the embodiment, the RW function and the RFID tag function use one antenna, a pair of modulation & demodulation circuits, and a pair of bit coding units for modulation & demodulation in common; however, according to the present invention, it is enough that at least the antenna is used in common. Moreover, according to the first and second embodiments, respective different control functions are assigned to the controller and the RW/RFID controller; however, this can be realized by one controller.

Further, the present invention is not limited to the specifically disclosed embodiments, and variations and modifications may be made without departing from the scope of the present invention.

The present invention is based on Japanese Priority Patent Application No. 2004-250152, filed on Aug. 30, 2004, with the Japanese Patent Office, the entire contents of which are hereby incorporated by reference.

What is claimed is:

1. A communication device, comprising:
a controller that outputs a signal;
an antenna that transmits a radio wave which corresponds to the signal output from the controller and also outputs a signal which corresponds to a received radio wave to the controller;
a first function that receives a signal, which responds to a first radio wave transmitted from the antenna, at the antenna;
a second function that receives a second radio wave transmitted from another communication device at the antenna and also returns a signal output from the controller in response to the second radio wave from the antenna; and
a unit that prevents the execution of the second function while the first function is being executed and prevents the execution of the first function while the second function is being executed.

2. The communication device as claimed in claim 1, wherein the controller comprises a unit that permits the execution of the first function when the controller receives a first function start signal and permits the execution of the second function when the controller receives a second function start signal at an idle status in which the communication device is executing neither the first function nor the second function.

3. The communication device as claimed in claim 2, further comprising:
a unit that restores the idle status when the first function is finished and restores the idle status when the second function is finished.

4. The communication device as claimed in claim 2, further comprising:
a second function starting unit that detects an electric change induced at the antenna and outputs a signal corresponding to the second function start signal.

5. The communication device as claimed in claim 1, further comprising:
a switch that selects either the first function or the second function.

6. The communication device as claimed in claim 1, further comprising:
a modulation unit that modulates the signal output from the controller; and
a demodulation unit that demodulates the signal output from the antenna;
wherein the modulation system of the modulation unit and the demodulation system of the demodulation unit are the same.

7. The communication device as claimed in claim 6, wherein the modulation system is an ASK modulation system.

8. The communication device as claimed in claim 1, further comprising:
an encoding unit that encodes a first signal output from the controller; and
a decoding unit that decodes a signal output from the demodulation unit;
wherein an encoding system of the encoding unit and a decoding system of the decoding unit are the same.

9. The communication device as claimed in claim 1, further comprising:
a power generating unit that generates power by utilizing power induced at the antenna by the second radio wave.

10. A communication device, comprising:
a controller that outputs a signal;
a first modulation unit that modulates the signal output from the controller by a first modulation system;
a second modulation unit that modulates the signal output from the controller by a second modulation system different from the first modulation system;
a modulation selecting unit that selectively sends the signal output from the controller to the first modulation unit or the second modulation unit;
an antenna that transmits a radio wave corresponding to a signal output from the first modulation unit or the second modulation unit selected at the modulation selecting unit;
a first demodulation unit that demodulates a signal corresponding to a radio wave received at the antenna by a first demodulation system;
a second demodulation unit that demodulates a signal corresponding to a radio wave received at the antenna by a second demodulation system;
a demodulation selecting unit that selectively sends a signal corresponding to the radio wave received at the antenna to the first demodulation unit or the second demodulation unit and also sends a signal demodulated at the first demodulation unit or the second demodulation unit to the controller;
a first function that selects the first modulation unit by the modulation selecting unit and selects the first demodulation unit by the demodulation selecting unit, and transmits a first radio wave from the antenna by modulating the signal output from the controller at the first modulation unit, and demodulates a signal responding to the first radio wave at the first demodulation unit and sends the demodulated signal to the controller;
a second function that selects the second modulation unit by the modulation selecting unit and selects the second demodulation unit by the demodulation selecting unit, receives a second radio wave transmitted from another communication device at the antenna, demodulates a signal corresponding to the second radio wave at the second demodulation unit and sends the demodulated signal to the controller, and returns a signal output from the controller corresponding to the signal corresponding to the second radio wave from the antenna to another communication device; and
a unit that prevents the execution of the second function while the first function is being executed and prevents the execution of the first function while the second function is being executed.

11. The communication device as claimed in claim 10, wherein the controller comprises a unit that permits the execution of the first function when the controller receives a first function start signal and permits the execution of the second function when the controller receives a second function start signal at an idle status in which the communication device is executing neither the first function nor the second function.

12. The communication device as claimed in claim 11, further comprising:
a unit that restores the idle status when the first function is finished and restores the idle status when the second function is finished.

13. The communication device as claimed in claim 11, further comprising:
a second function starting unit that detects an electric change induced at the antenna and outputs a signal corresponding to the second function start signal.

14. The communication device as claimed in claim 10, further comprising:
a switch that selects either the first function or the second function.

15. The communication device as claimed in claim 10, wherein the first modulation system of the first modulation unit and the second demodulation system of the second demodulation unit are the same.

16. The communication device as claimed in claim 15, wherein the first modulation system is an ASK modulation system.

17. The communication device as claimed in claim 10, further comprising:
a first encoding unit that encodes a first signal output from the controller; and
a second decoding unit that decodes a signal output from the second demodulation unit;
wherein an encoding system of the first encoding unit and a decoding system of the second decoding unit are the same.

18. The communication device as claimed in claim 10, further comprising:
a power generating unit that generates power by utilizing power induced at the antenna by the second radio wave.

19. A portable electronic instrument providing the communication device as claimed in claim 1.

20. A portable electronic instrument providing the communication device as claimed in claim 10.
